(19) United States
(12) Patent Application Publication
(10) Pub. No.: US 2011/0032518 A1
(43) Pub. Date: Feb. 10, 2011

(54) DETECTION ASSEMBLY

(75) Inventors: Brian Culshaw, Bridge of Weir Renfrewshire (GB); Alistair MacLean, South Uist Western Isles (GB); John Mccormack, Mold Flintshire (GB)

Correspondence Address: SHERIDAN ROSS PC, 1560 BROADWAY, SUITE 1200, DENVER, CO, 80202, US

(73) Assignee: SOLUS SENSORS LIMITED, St. Asaph (GB)

(21) Appl. No.: 12/921,115

(22) PCT Filed: Mar. 5, 2009
(86) PCT No.: PCT/GB2009/050225

§ 371 Date: Sep. 3, 2010

(30) Foreign Application Priority Data
Mar. 5, 2008 (GB) 0804109.7

(51) Int. Cl. G01N 21/00

(52) U.S. Cl. 356/73.1

(57) ABSTRACT

A detection assembly comprising: a body portion having a slot formed along at least a portion of a length thereof, the slot having a slot opening formed in an outer surface of the body portion, the slot opening being arranged to receive a sensor optical fibre through the slot opening; a sensor optical fibre constrained to lie in said slot and in juxtaposition with a plurality of protrusions; and at least one swell member, the swell member being configured to increase in volume in response to exposure to a target measurand, the detection assembly being arranged whereby an increase in a volume of said swell member causes said sensor optical fibre to be urged against at least one of said plurality of protrusions thereby to cause bending of said sensor optical fibre.

### FIELD OF THE INVENTION

The present invention relates to detection assemblies for sensing an environment. In particular but not exclusively the invention relates to a detection assembly in the form of a cable having one or more optical fibres for sensing fluids in an environment.

### BACKGROUND

It is known to use one or more optical fibres in sensor applications, as well as in conventional data transmission applications such as in telecommunications.

Optical measurement apparatus can be made sufficiently sensitive to detect optical attenuation of light passing through an optical fibre due to small local deformities or bends in the fibre. Such deformities may be referred to as ‘microbends’ when they occur on a length scale of the order of a few microns to a few hundred microns. Sensitivity of detection can be enhanced by inducing microbends at a plurality of positions along a length of a fibre. Reference herein to ‘bends’ includes reference to such ‘microbends’.

WO 94/18536 discloses a detection system which includes a probe assembly and a sensor assembly. The probe assembly has an optical fibre and an expandable material that is subject to an increase in volume (expansion) on exposure to a target measurand. The optical fibre is either provided on an outer surface of a former, being tightly bound thereto by a wound coil, or enclosed within a body in the form of a hollow cylindrical shell in juxtaposition with a plurality of teeth. The probe assembly is configured such that when the expandable material expands, the optical fibre is pressed either against the wound coil or the plurality of teeth, causing bending of the fibre.

### STATEMENT OF THE INVENTION

In a first aspect of the present invention there is provided a detection assembly comprising: a body portion having a slot formed along at least a portion of a length thereof, the slot having a slot opening formed in an outer surface of the body portion, the slot opening being arranged to receive a sensor optical fibre through the slot opening; a sensor optical fibre constrained to lie in said slot and in juxtaposition with a plurality of protrusions; and at least one swell member, the swell member being configured to increase in volume in response to exposure to a target measurand, the detection assembly being arranged whereby an increase in a volume of said swell member causes said sensor optical fibre to be urged against at least one of said plurality of protrusions thereby to cause bending of said sensor optical fibre.

Such a detection assembly has the advantage over some embodiments of WO 94/18536 that the optical fibre may be combined with a body portion of the detection assembly after manufacture of the body portion. This has the advantage of enhancing a flexibility of a process by which the detection assembly may be manufactured since an optical fibre may be simply ‘slotted’ into the slots formed in the body portion.

In contrast, in some of the structures disclosed in WO 94/18536 a restraining braid 30 must be formed around the optical fibre to bind the fibre to a core in a relatively complex manufacturing process. In other structures of WO 94/18536 the fibre must be embedded in a hollow cylindrical shell. In situations where the shell is relatively long compared with its diameter (e.g. having a length greater than 10-100 times its diameter) manufacture of the structure presents a number of process problems.

In contrast, in some embodiments of the present invention the optical fibre may be simply slotted into a slot formed in the outer surface of the body portion in a convenient manner that is readily compatible with the production of long lengths of the detection assembly.

A plurality of first protrusions may be provided along a first portion of a length of the slot, the first protrusions having a first spacing therebetween; and a plurality of second protrusions may be provided along a second portion of a length of the slot, the second protrusions having a second spacing therebetween.

The first spacing may be substantially equal to the second spacing.

Alternatively the first spacing may be different from the second spacing.

The slot may be formed to be substantially straight along at least a portion of a length of the slot.

Alternatively or in addition the slot may be formed to twist around the body portion along at least a portion of a length of the body portion.

Preferably in embodiments having a slot formed to twist around the body portion the slot is formed to have a substantially helical form.

Embodiments in which the slot twists around the body portion in an axial direction have the advantage that bending stress on an optical fibre provided in the slot during manufacture and installation is reduced.

Preferably the slot is provided in the body portion along substantially the entire length of the body portion.

Preferably the slot is further arranged to receive a bender insert member therein, the bender insert member providing at least one of said plurality of the protrusions.

Preferably the bender insert member provides a plurality of the protrusions.

A plurality of bender insert members may be provided along a length of said slot.

Preferably a first bender insert member has a plurality of protrusions of said first spacing and a second bender insert member has a plurality of protrusions of said second spacing.

Preferably said bender insert members are provided in spaced apart relationship along a length of the slot.

Alternatively a single bender insert member may be provided, the bender insert member spanning substantially the entire length of the slot.

Alternatively or in addition a plurality of said protrusions may be formed in a wall of said slot.

This has the advantage that in some embodiments of the invention insertion of a separate bender insert member into a slot is not required. The protrusions may be formed in a wall of the slot by moulding, during a process of extrusion, or by mechanical removal following formation of a slot.

A plurality of protrusions may be formed in a portion of the wall that is spaced apart from the slot opening.

Alternatively or in addition a plurality of protrusions may be formed in a portion of the wall of the slot immediately adjacent the slot opening.

Preferably the swell member is provided in the form of a swell insert member arranged to be insertable into said slot.

Preferably a plurality of swell insert members are provided along the length of the slot.

The plurality of swell insert members may be provided in a mutually spaced apart configuration along the length of the slot.

Alternatively a single swell insert member may be provided, a length of the swell insert member spanning substantially the entire length of the slot.

Preferably the body portion is provided with a plurality of slots therealong.

Preferably at least one of said plurality of slots is not provided with plurality of protrusions therealong.

In some embodiments at least one of said plurality of slots is not provided with a swell member therein.

Preferably first and second slots of said plurality of slots are provided with respective first and second swell members therein.

Alternatively or in addition the first and second swell members may be provided in the same slot.

Preferably the first and second swell members are configured to increase in volume by different respective amounts in response to exposure to a target measurand.

The first and second swell members may be configured to be responsive to different respective target measurands.

Preferably a swell member is configured to undergo an increase in volume in response to exposure to a fluid.

The fluid may comprise at least one selected from amongst water, an aqueous solution, and a hydrocarbon such as petrol, diesel, oil, mineral oil, a solvent and petroleum spirit.

The swell member may be configured to increase in volume in response to exposure to a liquid.

Alternatively or in addition the swell member may be configured to increase in volume in response to exposure to a gas.

Preferably a sheath member is provided around an outside of the body portion.

Preferably the sheath member comprises a membrane through which said target measurand may pass.

This has the advantage that the sheath member may be provided along an entire length of the body portion since it does not interfere substantially with exposure of the swell member to a target measurand.

The sheath member may comprise a tape member.

The sheath member may be a heatshrunk sheath member. Alternatively or in addition the sheath may be formed around the body portions by a process of extrusion.

The sheath member may be arranged to promote passage of the target measure and through the sheath.

The sheath may comprise at least one selected from amongst a hydrophobic material and a hydrophilic material.

Preferably the sheath member twists around the body portion along at least a portion of a length of the body portion.

More preferably the sheath member is in the shape of a helix.

Preferably a swell member has at least one exposure surface, an exposure surface being a surface arranged whereby a target measurand external to the detection assembly may enter the swell member by passage therethrough.

Preferably the detection assembly comprises a channel portion, the channel portion being provided in fluid communication with the swell member, the channel portion being arranged whereby a gaseous environment to which a portion of a surface of the swell member not being an exposure surface of the swell member is exposed may be changed.

The channel portion may be arranged whereby the gaseous environment to which said portion of a surface of the swell member not being an exposure surface is exposed is arranged to be at least one selected from amongst an evacuated atmosphere and an atmosphere having a prescribed moisture content.

A swell member may be provided by the body portion.

In other words, the body portion may itself be formed from material that increases in volume in response to exposure to a target measurand. This has the advantage that in some embodiments a separate swell member component is not required, thereby simplifying manufacture.

A sensor optical fibre may be provided with a reflector element at one end, the reflector element being arranged to reflect an optical radiation signal propagating along the optical fibre and incident upon said reflector member back along the optical fibre in an opposite direction.

This has the advantage that an optical radiation signal transmitter and receiver may be positioned at the same end of the sensor optical fibre.

The reflector member may be provided by a surface of an end of the optical fibre.

Alternatively the reflector member may comprise a reflective coating provided over a surface of a free end of the optical fibre.

A slot of the body portion may be formed to have a portion having a cross-section in the form of one selected from amongst a square, a rectangle, substantially a U-shape and substantially a V-shape.

Preferably the detection assembly is provided in combination with controller apparatus configured to detect bending or microbending of said sensor optical fibre.

Preferably the controller apparatus is arranged to measure an amount of attenuation of a signal passed along a fibre and to detect an increase in attenuation caused by bending of the fibre due to exposure of a swell member to a target measurand.

The controller apparatus may be configured to determine a distance along the optical fibre at which exposure of a swell member to a target measurand has occurred.

The controller apparatus may be arranged to determine the distance along the optical fibre at which exposure of a swell member to a target measurand has occurred by means of optical time domain reflectometry (OTDR).

The detection assembly may be arranged to allow a source of optical radiation to be removably coupled to the sensor optical fibre.

The detection assembly may comprise a plurality of sensor optical fibres wherein at least a first sensor optical fibre is coupled to the controller apparatus whereby microbending of the at least one sensor optical fibre may be detected.

Preferably at least a second sensor optical fibre of the plurality of sensor optical fibres is arranged to be removably coupled to a further measurement apparatus.

This has the advantage that the further measurement apparatus need not be permanently coupled to the fibre, allowing the measurement apparatus to be coupled to different measurement apparatus at different physical locations.

Preferably the further measurement apparatus comprises OTDR apparatus.

Alternatively at least a second sensor optical fibre of the plurality of sensor optical fibres may be fixedly coupled to a further measurement apparatus.

The further measurement apparatus may comprise OTDR apparatus permanently associated with the detection assembly at a given physical location.

The first sensor optical fibre may be arranged to attenuate a signal more strongly than the second sensor optical fibre.

The first sensor optical fibre is arranged to attenuate a signal more strongly than the second sensor optical fibre when the sensor optical fibres are subjected to microbending.

Alternatively, the first sensor optical fibre may be arranged to attenuate a signal less strongly than the second sensor optical fibre.

The first sensor optical fibre may be arranged to attenuate a signal less strongly than the second sensor optical fibre when the sensor optical fibres are subjected to microbending.

An optical fibre of the detection assembly may be coupled to a telecommunications network.

Preferably at least one of said plurality of slots that is not provided with a plurality of protrusions therealong is provided with a data optical fibre coupled to apparatus arranged to transmit at least one selected from amongst telecommunications data and a reference signal along the data optical fibre.

Preferably at least one of said plurality of slots that is not provided with a swell member therein is provided with a data optical fibre coupled to apparatus arranged to transmit at least one selected from amongst telecommunications data and a reference signal along the data optical fibre.

The apparatus may be arranged to transmit a reference signal along the data optical fibre and a sensor optical signal along the sensor optical fibre, the apparatus being further configured to detect the respective signals and to compare said signals thereby to compensate for changes in the sensor optical signal not due to an increase in volume of a swell member.

This has the advantage of increasing a sensitivity of the apparatus to the detection of bending or microbending due to a sensor optical fibre being urged against one or more protrusions.

The controller apparatus may be configured to measure at least one selected from amongst a temperature and an intensity of a vibration of a portion of an optical fibre based on a change in an optical signal transmitted along said optical fibre.

This has the advantage that in some embodiments of the invention the detection assembly can be used to measure a temperature of a portion of the sensor optical fibre in applications in which such information is of value. In some embodiments configured to measure vibrations, the detection assembly can be configured to detect a presence of an intruder.

The apparatus may be further configured to transmit a telecommunications data signal along the data optical fibre.

The apparatus may be configured to transmit the telecommunications data signal along the data optical fibre substantially simultaneously with the reference signal.

Alternatively or in addition the apparatus may be configured to transmit the telecommunications data signal along the data optical fibre at a different time to the reference signal. In some embodiments, a plurality of fibres are provided in a slot, one fibre being arranged to carry a reference signal, another fibre being arranged to carry a telecommunications data signal.

In embodiments where a plurality of optical fibres are provided in a slot not having protrusions and/or a swell member, one optical fibre may be arranged to carry a reference signal and another optical fibre may be arranged to carry a telecommunications data signal.

Preferably the body portion is formed from a flexible material.

The body portion may comprise a plastics material.

The body portion may comprise at least one selected from amongst polyester, polybutylene terephthalate and polyethylene

The body portion may comprise a high modulus polymer.

Preferably the body portion is an elongate member.

The body portion may have a substantially circular cross-section. It is to be understood that the body portion may be considered to have a substantially circular cross-section despite the presence of one or more slots in the body portion.

The detection assembly may be in the form of a cable.

The detection assembly may be provided directly onto a substrate. The detection assembly may be provided with a substantially flat outer surface to allow the assembly to be more readily coupled to the substrate.

The substrate may comprise a circuit board.

In a second as aspect of the invention there is provided a circuit board having a detection assembly according to the first aspect provided thereon.

In a third aspect of the invention there is provided a cable comprising a detection assembly according to the first aspect.

In a fourth aspect of the invention there is provided a telecommunications network comprising a cable according to the second aspect.

### BRIEF DESCRIPTION OF THE DRAWINGS

Embodiments of the invention will now be described with reference to the accompanying figures in which:

FIG. 1 shows a perspective view of a sensor cable according to an embodiment of the invention;

FIG. 2 shows a cross-sectional view of a sensor cable according to the embodiment of FIG. 1;

FIG. 3 shows a cable according to an embodiment of the invention coupled to optical time domain reflectometry (OTDR) apparatus for measurements in pipelines;

FIG. 4 shows an embodiment of the invention having two sensor optical fibres in respective different slots and a further slot having communication optical fibres therein;

FIG. 5 shows a cross-sectional view of a sensor cable according to an embodiment of the invention having a radially disposed bender insert member;

FIG. 6 shows a cable having a cavity formed along an inner portion of the body portion in fluid communication with the swell member;

FIG. 7 shows a cross-sectional view of a cable according to an embodiment of the invention in which corrugations are provided in a body portion of the cable rather than by means of a bender insert member;

FIG. 8 shows a cable according to an embodiment of the invention coupled to optical time domain reflectometry (OTDR) apparatus for measurements in downwell situations;

FIG. 9 shows a cable according to an embodiment of the invention coupled to attenuation measurement apparatus, a source and a detector being provided at opposite ends of the sensor cable; and

FIG. 10 shows a cable according to an embodiment of the invention coupled to attenuation measurement apparatus, the source and detector being provided at the same end of the sensor cable.

### DETAILED DESCRIPTION

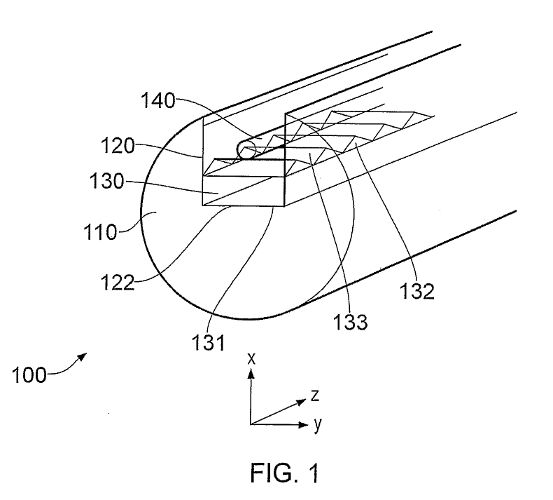

In one embodiment of the invention a cable 100 is provided (FIG. 1) having a body portion 110. In some embodiments the body portion 110 is formed from a suitable flexible plastics material such as a high modulus polymer, polyester, polybutylene terephthalate, or polyethylene. Other materials are also useful. In the embodiment shown the body portion 110 is substantially circular in cross-section. Other cross-sectional shapes are also useful including square, rectangular, polygonal, oblong, elliptical, and any other suitable shape.

A slot 120 is formed in the cable along a length of the cable. The slot 120 is open at an outer circumferential surface of the body portion 110. In the embodiment of FIG. 1 the slot 120 has a generally rectangular profile in cross-section. Other shapes of a cross-section of the slot are also useful.

A bender insert member 130 is provided in the slot 120, a generally planar face of the bender insert member 130 being provided in abutment with an inner basal face 122 of the slot 120. An opposite face of the bender insert member 130 is provided with a corrugated profile in a direction along a length of the cable 100, i.e. along a longitudinal axis indicated ‘z’ in FIG. 1. As viewed along a y-direction (FIG. 1) corrugations of bender insert member 130 have a generally symmetrical triangular form. Other shapes of corrugation are also useful.

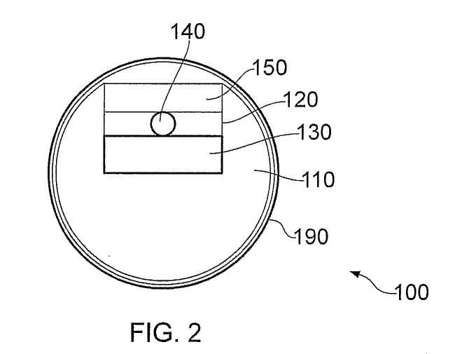

FIG. 2 shows an optical fibre 140 provided over the bender insert member 130 along a length of the cable 100. A swell member 150 is provided in the slot 120 above the optical fibre 140 such that the optical fibre 140 is sandwiched between the bender insert member 130 and the swell member 150 in abutment with both members. Thus, in the embodiment of FIG. 1 and FIG. 2 the optical fibre 140 is arranged to contact the bender member 140 at apices of the corrugations 132.

In some embodiments the swell member 150 is formed from a swellable polymer such as a silicone or a hydogel. Other materials that increase in volume in response to exposure to a target measurand are also useful. For example, in some embodiments the swell member 150 is formed from a material that increases in volume when exposed to one or more of a subset of liquids, gases and/or vapours. For example, in some embodiments the swell member is configured to increase in volume upon exposure to at least one selected from amongst water, an aqueous solution, and a hydrocarbon such as petrol, diesel, oil, mineral oil, a solvent and petroleum spirit.

A porous sheath member 190 is provided around the body portion 110 of the cable 100 to retain the bender insert member 130 and swell member 150 within the slot 120. In the embodiment of FIGS. 1 and 2 the sheath member is formed from a porous polymer tape. Other functionally equivalent materials allowing a medium to be detected to pass through are also useful.

The sheath 190 may be provided around the body portion by heat-shrinking, by extrusion, or a combination thereof.

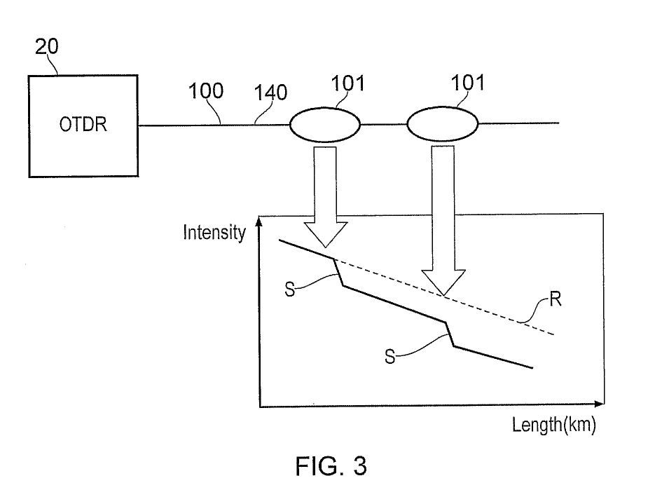

FIG. 3 is a schematic illustration of a cable according to an embodiment of the invention connected to optical time domain reflectometer (OTDR) apparatus 20.

The OTDR apparatus 20 is configured to inject a series of optical pulses into the sensor optical fibre 140 and to detect portions of this beam that are scattered back along the fibre. Scattering of an optical beam passing along an optical fibre occurs to some extent in substantially all optical fibres due to variations in composition and other defects introduced during manufacture of the fibre.

However, an increase in an amount of radiation ‘backscattered’ along a fibre will increase substantially in regions wherein bending of the fibre is induced due to a sufficient increase in volume of a swell member. This increase in backscattered radiation may be detected by the OTDR apparatus.

The OTDR apparatus 20 is configured to integrate the intensity of reflected pulses of radiation as a function of time. A plot of reflected pulse intensity as a function of length of the fibre obtained by an OTDR apparatus is shown in FIG. 3.

Trace ‘R’ corresponds to an expected or ‘reference’ trace of a fibre not having microbending along its length due to expansion of a swell member. The reference trace is obtained prior to exposure of the fibre to a target measurand that causes swelling of the swell member 150. The observed decrease in backscattered intensity as a function of distance along the fibre is primarily due to scattering of laser radiation due to variations in refractive index at a level expected of as-manufactured optical fibre.

In the case that the cable 100 is exposed at one or more portions of the length to a target measurand causing swelling of the swell member 150, scattering of radiation is intensified at locations 101 of the cable at which a portion of the swell member 150 is exposed to the target measurand. Scattering at these locations causes leakage of radiation from the cable at that location. This results in a more rapid decrease in the intensity of radiation propagating along the optical fibre away from the radiation source.

Thus, at locations of the swell member 150 where the swell member 150 has been ‘activated’ by exposure to target measurand, resulting in an increase in volume of the swell member 150 and the application of pressure to the sensor optical fibre 140, a steeper decrease in the amount of radiation back-scattered along the fibre occurs. This results in a change in slope of a plot of backscattered intensity as a function of length of the fibre, as can be seen at positions ‘S’ of the plot of FIG. 3.

In some embodiments of the invention OTDR apparatus is provided that is configured to provide an alert in the event that swelling of a portion of the swell member 150 is detected. In some embodiments the apparatus is also configured to provide an indication of a location of the portion of the swell member 150 that has become swollen.

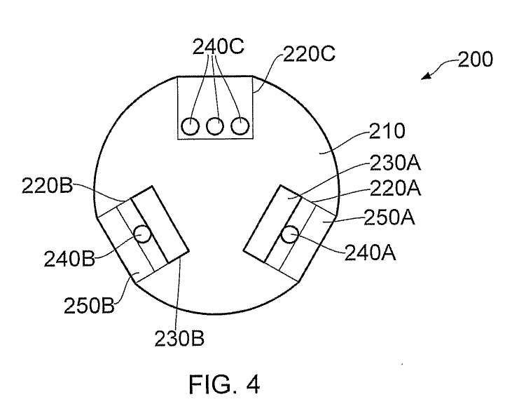

FIG. 4 shows an embodiment of the invention in which a cable 200 is provided having three slots 220A to C formed therealong. It will be appreciated that in some embodiments other numbers of slots may be provided including 2, 4, 5, 6, 7, 8 or any other number.

In the embodiment of FIG. 4 two of the slots 220A, 220B are provided with a respective bender insert member 230A, 230B, sensor optical fibre 240A, 240B and swell member 250A, 250B. In the embodiment of FIG. 4 swell member 250A differs from swell member 250B in that swell member 250B increases in volume by a larger amount than swell member 250A following exposure to the same amount of target measurand. Thus, swell member 250B may be said to be of a higher ‘sensitivity’ to exposure to fluid than swell member 250A.

In use, the sensor optical fibres 240A, 240B are connected to OTDR apparatus and variations in intensity of respective beams of radiation injected into the fibres 240A, 240B are monitored as a function of distance along the fibre. The OTDR apparatus is arranged to detect bending of the fibre due to exposure of one or more portions of the swell members 150A, 150B to target measurand.

A third slot 220C of the embodiment of FIG. 4 is provided with no bender insert member 230 or swell member 250. Rather, the slot is provided with communications optical fibres 240C arranged to carry telecommunications signals.

It will be appreciated that the third slot 220C can alternatively or in addition be used to carry optical fibres for other purposes such as for temperature measurement or vibration or intruder detection. Other articles can be provided in the third slot 220C instead of or in addition to optical fibres including conducting cables, fluid conduits, or any other article that may be fitted into the slot 220C.

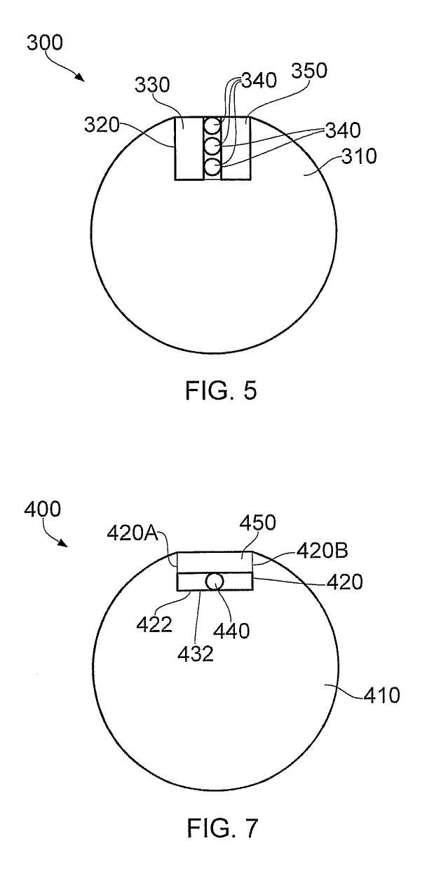

FIG. 5 shows an embodiment in which an orientation of a bender insert member 330 and swell member 350 is rotated through an angle of substantially 90° relative to that of the embodiments of FIGS. 1 and 2.

It will be understood that one or a plurality of sensor optical fibres may be sandwiched between any given bender insert member 130, 230, 330 and swell member 150, 250, 350. In the embodiment of FIG. 5 three sensor optical fibres 340 are shown sandwiched between the bender insert member 330 and swell member 350, by way of example.

It will be appreciated that in some embodiments the positions of the bender insert member 130, 230, 330 and swell member 150, 250, 350 are reversed. In other words, in the embodiments of FIGS. 1 to 4 the swell member may be inserted into the slot before the bender insert member. It will be appreciated that in such embodiments apertures or other openings may be required (e.g. in the bender insert member) to allow target measurand to access the swell member thereby to cause swelling of the swell member.

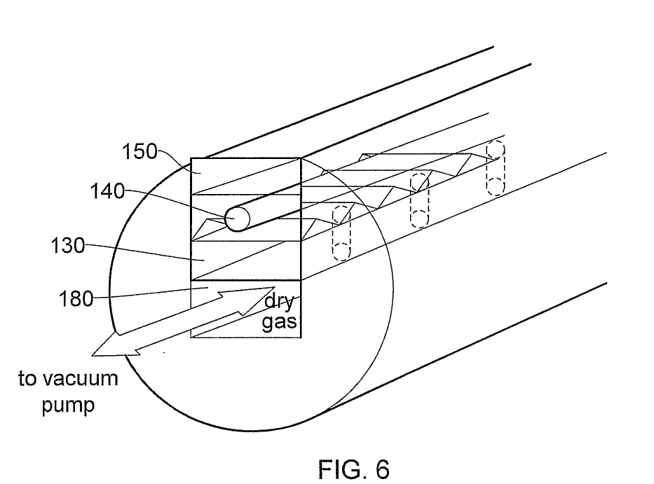

In some embodiments of the invention such as that shown in FIG. 6, a sensor optical fibre 140 and associated bender insert member 130 are sandwiched between a swell member 150 and a cavity 180. The cavity 180 is in fluid communication with the swell member 150 such that evacuation of the cavity 180 promotes target measurand to be drawn through the swell member 150 from an external environment 199.

In some embodiments, instead of evacuating the cavity 180, the cavity is arranged to be coupled to a source of a dry gas. The dry gas is chosen such that introduction of the dry gas into the cavity 180 promotes an increase in an amount of target measurand in the swell member 150. In some embodiments, evacuation of the cavity or the introduction of dry gas increases the amount of target measurand that enters the swell member 150 from an environment in which a sensing operation is to be performed.

In some embodiments, evacuation of the cavity 180 or the introduction of dry gas into the cavity increases the concentration of target measurand in the swell member 150.

In some embodiments the increase in concentration of target measurand in the swell member 150 occurs selectively. In some embodiments, a target measurand in the form of a fluid passes selectively into the swell member 150 from an environment due to evacuation of the cavity 180 or the presence of dry gas in the cavity 180. In some embodiments the increase in concentration of target measurand in the swell member 150 occurs by a process of pervaporation.

In some embodiments of the invention a plurality of bender insert members 130 and/or swell members 150 are provided along a length of the cable instead of a single continuous member 130, 150.

In some embodiments respective swell members 150 and/or bender insert members 130 are provided in spaced apart relationship along a length of the cable.

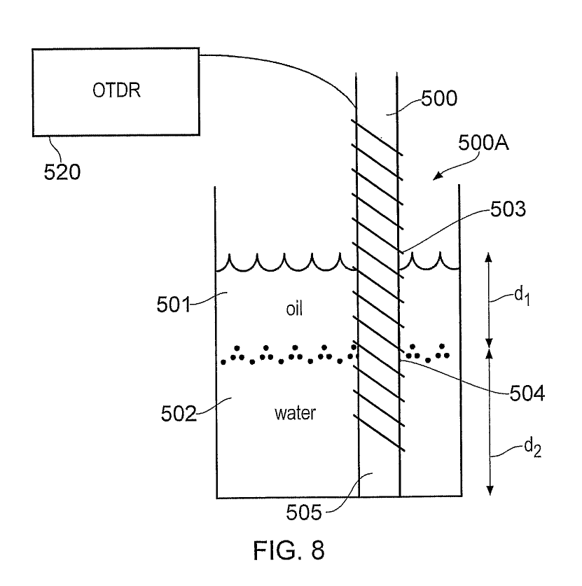

FIG. 7 shows a cable 400 according to an embodiment of the invention wherein instead of providing a bender insert member, corrugations or other protrusions 432 are provided in the body portion 410 of the cable. The corrugations may be formed in the body portion 410 during a moulding operation or by cutting, stamping or other suitable technique following forming of the body portion 410.

In the embodiment of FIG. 7 the sensor optical fibre 440 is shown sandwiched between corrugations 432 of the body portion 410 and a swell member 450. In the embodiment of FIG. 7 the corrugations are shown formed in a basal face 422 of the slot 420. It will be appreciated that in some embodiments the corrugations or other protrusions may be formed in another surface instead of or in addition to the basal surface. In some embodiments corrugations or other protrusions are formed in one or more sidewalls 420A, B.

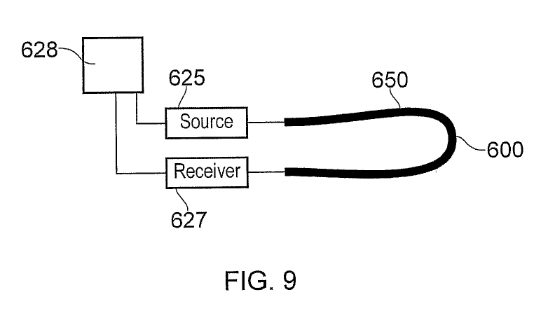

FIG. 8 is a schematic illustration of a cable 500 according to an embodiment of the invention wound on a former 505 to form a cable assembly 500A. The cable 500 is coupled to OTDR apparatus 520 at a free end of the cable 500.

In the embodiment shown in FIG. 8 the cable assembly 500A has been placed in a well. The cable assembly 500A may also be placed in other locations such as in a fluid storage tank. The assembly 500A in combination with OTDR apparatus 520 is configured to detect the presence of hydrocarbon. In the example shown in FIG. 8, it can be seen that a layer of a hydrocarbon 501 of depth d₁ is present above a volume of water 502 of depth d₂. A swell member of the cable 500 is arranged to increase in volume in response to the presence of hydrocarbon and not to increase in volume in response to the presence of water. Thus, bending of the portion of the fibre between positions 503 and 504 of the fibre 500 will occur, the bending being detected by the OTDR apparatus 520.

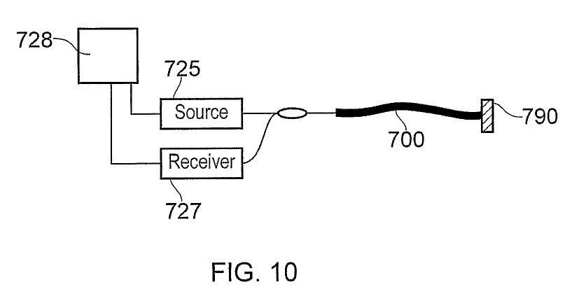

FIG. 9 shows an arrangement in which a sensor cable 600 is coupled at one end to a source 625 of an optical radiation signal and at the opposite end to a receiver 627. The receiver is arranged to detect an intensity of the optical radiation signal generated by the source 625 that arrives at the receiver 627.

In the embodiment shown, a controller 628 is arranged to measure an amount of attenuation of the optical radiation signal from the source 625 that is detected by the detector 627 after the signal has passed through the cable 600.

The amount of attenuation of the signal provides an indication that an event has occurred a consequence of which is that swelling of at least a portion of a swell member 650 of the cable 600 has occurred.

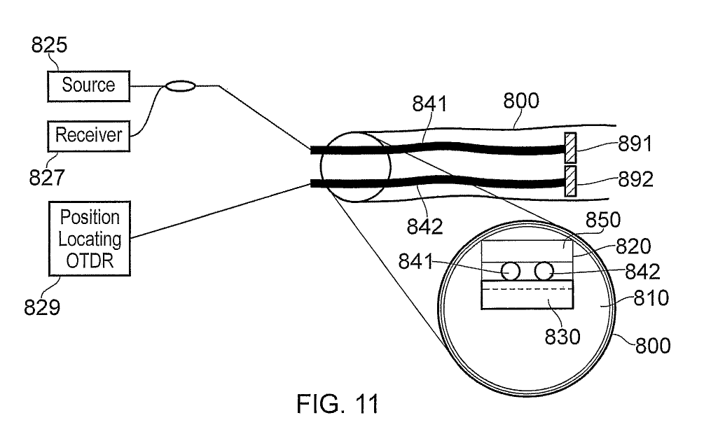

FIG. 10 shows an arrangement in which an attenuation measurement of an optical radiation signal in a cable 700 is performed in a reflection mode. In the arrangement shown, a sensor optical fibre of the cable 700 is coupled to both a source 725 of optical radiation and a receiver 727 arranged to detect an intensity of the optical radiation signal generated by the source 725 that arrives at the receiver 727. At an opposite end of the cable 700 a reflector element 790 is provided. The reflector element 790 is arranged to reflect the optical radiation signal generated by the source 725 that passes along the sensor optical fibre back along the sensor optical fibre towards the receiver 727. As in the case of the embodiment of FIG. 9, a controller 728 is arranged to measure an amount of attenuation of this signal. An increase in the amount of attenuation indicates that microbending of the sensor optical fibre has occurred, indicating the presence of a target measurand.

It is to be appreciated that in the embodiments of FIG. 9 and FIG. 10 an axial location of bending cannot be determined since the controllers 628, 728 are arranged to measure attenuation of the signal only.

In some embodiments apparatus is provided that is arranged to measure attenuation of the optical signal in addition to performing OTDR. Thus, in some embodiments detection of a leak may be performed by measuring attenuation of the optical signal whilst a location of a microbend in the fibre may be determined using OTDR apparatus.

In some embodiments the OTDR apparatus is arranged to perform OTDR inspection of the fibre once microbending of the fibre due to (say) a leak has been determined. Thus, in some embodiments the apparatus is not required to perform OTDR inspection continually.

In some embodiments of the invention the apparatus is arranged to allow OTDR apparatus to be removably coupled to the fibre optic cable when it is required to determine a location of a leak that has been detected by the controllers 628,728.

In some embodiments a plurality of sensor optical fibres are provided, being arranged to experience microbending in the presence of target measurand as described above.

One of the sensor optical fibres may be used to perform attenuation measurements whilst the other sensor optical fibre may be used to perform OTDR inspection. In some embodiments in which more than one sensor optical fibre is arranged to experience microbending a first sensor optical fibre may be arranged to attenuate an optical beam to a greater extent than a second sensor optical fibre. Thus the apparatus may be arranged to measure attenuation of an optical signal being passed through the first fibre thereby to detect the presence of a target measurand and to allow OTDR to be performed using the second fibre in order to determine a location of a point at which a swell member has been exposed to target measurand in the event that target measurand is detected.

Thus, in some embodiments, a source 625, 725 and a receiver 627,727 are coupled to the first fibre. In some embodiments OTDR may be coupled to the second fibre permanently or as discussed above, when it is required to determine a location of a leak.

FIG. 11 is a schematic illustration of an embodiment of the invention in which a cable 800 is provided with a slot 820 in which a bender insert member 830 is provided at a base thereof.

First and second sensor optical fibres 841,842 respectively are sandwiched between the insert member 830 and a swell member 850 provided radially outwardly of the insert member 830. The swell member 850 is arranged to be exposed to a target measurand as described above.

The first sensor optical fibre is coupled to a source 825 and a receiver 827 at a first end of the fibre and a first reflector 891 is provided at a second end opposite the first end. Thus a beam of optical radiation from the source is arranged to pass along the first optical fibre 841 and to be reflected by the first reflector 891 back along the fibre 841 to the receiver 827.

The second fibre is arranged to be coupled to OTDR apparatus 829 at a first end, the second fibre having a second reflector 892 provided at the second end opposite the first end. In some embodiments the second reflector 892 may not be provided. In some embodiments the first and/or second reflector members are provided by a free end of the fibre. For example, in some embodiments the free end of the fibre is a cleaved end that is sufficiently smooth to provide a reflector member 891,892.

In some embodiments the first optical fibre 841 841 is arranged to attenuate light more strongly than the second optical fibre 842 when the cable is exposed to target measurand.

Embodiments of the invention such as that of FIG. 11 arranged to allow detection of a microbend by measuring attenuation of a signal in a first optical fibre in addition to allowing OTDR apparatus to be removably coupled to a second optical fibre to determine a location of a leak have a number of advantages in some applications. For example, a given installation is not required to be provided permanently with the capability to perform OTDR. Thus, a cost and complexity of the installation may be reduced. Furthermore, in some embodiments an overall power consumption of the apparatus may thereby be reduced.

Cables having a portion with a substantially flat surface along a length thereof are useful in some embodiments of the invention. Such cables are particularly useful for attachment to planar surfaces in certain applications.

For example in some embodiments a cable may be attached to a circuit board in order to detect water arising for example due to condensation or leakage from cooling elements.

In some embodiments apparatus may be provided that is arranged to detect condensation forming on racks of circuit boards. The cable may be bonded to the circuit board or arranged loosely to run within a housing or other environment in which the boards are provided.

In some embodiments apparatus may be arranged to trigger means for elimination of the condensation, such as a heater and/or a flow of air to remove the condensation.

Embodiments in which expansion of the swell member is reversible, allowing multiple use (as opposed to a swell member that is a “one shot” swell member) have the advantage that, once the condensation has been eliminated and the swell member has contracted such that microbending is no longer present (or at least an amount of microbending is reduced relative to the amount present when condensation was detected) the means for reducing the amount of condensation may be de-activated.

In some embodiments of the invention a detection assembly is provided in the form of a probe suitable for insertion into a liquid such as in a liquid storage tank, a well, a river, an ocean or any other body of water or body of gas. In some embodiments the probe is substantially rigid. In some embodiments the probe is provided in a form suitable for installation in a domestic, industrial or natural environment for detection of one or more gases such as carbon monoxide, or one or more vapours such as petroleum vapours, or one or more liquids, such as liquid petroleum, water etc.

In some embodiments the functionality of the bender insert member is provided by the swell member. In other words, the swell member is provided with protrusions arranged to cause microbending when the swell member expands. A separate additional one or more protrusions may also be provided. For example, a separate bender insert member may be provided. Alternatively or in addition protrusions may be provided in a wall of the slot as described above. In some embodiments protrusions of the swell member may be positioned in complementary positions to those provided in the wall of the slot or a separate bender insert member.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1-88. (canceled)

89. A detection assembly comprising:
a body portion having a slot formed along at least a portion of a length thereof, the slot having a slot opening formed in an outer surface of the body portion, the slot opening being arranged to receive a sensor optical fibre through the slot opening;
a sensor optical fibre constrained to lie in said slot and in juxtaposition with a plurality of protrusions;
at least one swell member, the swell member being configured to increase in volume in response to exposure to a target measured; and
the detection assembly being arranged whereby an increase in a volume of said swell member causes said sensor optical fibre to be urged against at least one of said plurality of protrusions thereby to cause bending of said sensor optical fibre.

90. A detection assembly as claimed in claim 89, comprising:
a plurality of first protrusions along a first portion of a length of the slot, the first protrusions having a first spacing therebetween; and
a plurality of second protrusions along a second portion of a length of the slot, the second protrusions having a second spacing therebetween.

91. A detection assembly as claimed in claim 89, wherein the slot is further arranged to receive a bender insert member therein, the bender insert member providing at least one of said plurality of protrusions.

92. A detection assembly as claimed in claim 89, wherein a plurality of said protrusions are formed in a wall of said slot.

93. A detection assembly as claimed in claim 89, wherein the swell member is provided in the form of a swell insert member arranged to be insertable into said slot.

94. A detection assembly as claimed in claim 93, comprising a plurality of swell insert members along the length of the slot.

95. A detection assembly as claimed in claim 93, wherein a single swell insert member is provided, a length of the swell insert member spanning substantially the entire length of the slot.

96. A detection assembly as claimed in claim 89, wherein the body portion is provided with a plurality of slots therealong and first and second slots of said plurality of slots are provided with respective first and second swell members therein and the first and second swell members are configured to be responsive to different respective target measurands.

97. A detection assembly as claimed in claim 89, wherein a swell member is configured to increase in volume in response to exposure to a gas.

98. A detection assembly as claimed in claim 89, wherein a swell member is provided with at least one exposure surface, an exposure surface being a surface arranged whereby target measurand external to the detection assembly may enter the swell member by passage therethrough and the assembly comprises a channel portion, the channel portion being provided in fluid communication with the swell member, the channel portion being arranged whereby a gaseous environment to which a portion of a surface of the swell member not being an exposure surface of the swell member is exposed may be changed.

99. A detection assembly as claimed in claim 89, wherein a sensor optical fibre is provided with a reflector element at a free end thereof, the reflector element being arranged to reflect an optical radiation signal propagating along the optical fibre and incident with said reflector member back along the optical fibre in an opposite direction.

100. A detection assembly as claimed in claim 89, wherein the body portion is provided with a plurality of slots therealong and at least one of said plurality of slots is not provided with a swell member therein, and wherein the at least one of said plurality of slots that is not provided with a swell member therein is provided with a data optical fibre coupled to apparatus arranged to transmit at least one selected from amongst telecommunications data and a reference signal along the data optical fibre.

101. A detection assembly as claimed in claim 89, in combination with controller apparatus configured to detect bending or microbending of said sensor optical fibre, wherein the controller apparatus is configured to measure at least one selected from amongst a temperature and an intensity of a vibration of a portion of an optical fibre based on a change in an optical signal transmitted along said optical fibre.

102. A circuit board having a detection assembly as claimed in claim 89.
